(19) United States
(12) Patent Application Publication
(10) Pub. No.: US 2016/0345048 A1
(43) Pub. Date: Nov. 24, 2016

(54) REMOTE CONTROLLER HAVING DUAL TOUCH PADS AND METHOD OF CONTROL USING THE SAME

(71) Applicant: Korea Electronics Technology Institute, Seongnam-si Gyeonggi-do (KR)

(72) Inventors: Kunnyun Kim, Yongin-si Gyeonggi-do (KR); Kwangbum Park, Yongin-si Gyeonggi-do (KR); Yeonhwa Kwak, Seoul (KR); Wonhyo Kim, Yongin-si, Gyeonggi-do (KR)

(21) Appl. No.: 14/903,454

(22) PCT Filed: Jul. 29, 2014
(86) PCT No.: PCT/KR2014/006909

§ 371 Date: Jan. 7, 2016

(30) Foreign Application Priority Data
Aug. 23, 2013 (KR) 10 2013 0100210

(51) Int. Cl. H04N 21/422; G06F 3/041; H04N 21/431; H04N 21/61; G06F 3/0484; G06F 3/0354

(52) U.S. Cl. CPC H04N 21/42224; G06F 3/04845; G06F 3/03547; H04N 21/4312; H04N 21/6125; G06F 3/0416; G06F 2203/04104

(57) ABSTRACT

Disclosed is a remote controller having a dual touch pad and a method of control using the same, the remote controller including a communication unit, a first touch pad, a second touch pad, an elastic layer, a position sensing unit, and a control unit. The first and second touch pads are installed adjacent to each other, and each have the elastic layer formed thereon, to output first and second selection signals, respectively, to control the control target device. The position sensing unit senses whether the first touch pad and the second touch pad are positioned in a longitudinal direction or in a traverse direction and outputs a third selection signal. The control unit receives at least one of the first to third selection signals from the first touch pad, the second touch pad, or the position sensing unit, and transmits a control signal to the control target device.

### TECHNICAL FIELD

Disclosed is a remote controller, and more particularly, to a remote controller having a dual touch pad providing a user environment in which a control target device is easily and conveniently controlled, and a method of control using the same.

### BACKGROUND ART

Various multimedia devices, including a television (TV) and a video cassette recorder (VCR), is provided with a remote controller that performs a remote control to enhance the convenience in use. The remote controller includes various buttons to manipulate the multimedia device. For example, a remote controller for a TV is provided with various function keys and buttons capable of manipulating channel change, volume up and down, and text entry so as to enable a television viewing.

Meanwhile, there has been a proliferation of a digital television that can perform an interactive communication between a broadcasting program provider and a viewer. The digital television is developed toward convergence to provide various multimedia contents. For a user interface that allows a user to easily use multimedia contents, the remote controller is able to add features, such as scroll and drag-and-drop.

Recently, combining internet access and installing various applications, a smart television has spread that can utilize various features, such as web surfing, video on demand (VOD) viewing, social networking service (SNS), and games.

However, while a variety of multimedia devices offer the scroll and the drag-and-drop feature, the remote controller does not include a separate device to utilize the features, so a user needs to be provided with a mouse that is usable by being connected to the multimedia device, or needs to perform a complicated manipulation process by using buttons.

In order to remove such an inconvenience, a remote controller having a track ball and a jog in addition to buttons is provided for a user to utilize the scroll feature and the drag and drop feature. However, there are still problems in that the track ball and the jog have poor durability due to the characteristic of mechanical operation, increase the price of the remote controller, and increase the size of the remote controller.

In order to remove the constraints, a remote controller having a touch pad has been introduced as disclosed in Korean Unexamined Patent Application Publication No. 2006-0008735. According to the remote controller having a touch pad, a touch pad serving as a mouse of a notebook computer is applied to a remote controller such that the touch pad is substituted for various function keys, buttons, a track ball or a jog, or the number of various function keys, buttons, a track ball or a jog may be reduced. In addition, the remote controller operates based on a combination of motions of a finger on the touch pad without confirmation of the function key or buttons, thereby simplifying the use of the multimedia device.

However, the existing remote controller having a touch pad is not convenient in entering a text, and the text entry is time consuming. In particular, when there is a need to enter a text required for using web surfing, messenger, and SNS as in smart TV, while displaying a virtual key pad on the TV screen, a text is entered through a flicking of the touch pad for transition, which takes a large amount of time.

In addition, when the a text is entered using a touch pad, a user contact the touch pad with a finger to move a pointer over a desired text and presses the touch pad to select the corresponding text. However, the surface of the touch pad is hard, which results in degradation of a touch sensibility, and causes difficulty in precisely recognizing whether the corresponding text is precisely selected through a tactile sensation of the finger.

In addition, when searching for a menu, a photo or an item of a list that is not displayed on the TV screen using the remote controller having the touch pad, a flicking of the touch pad is performed for the search. However, there is a problem in that, if there are a number of menus, photos or items of a list, it takes a long time to find out the desired menu, photo or item of a list.

In addition, if there is a need to enlarge or reduce a predetermined image, in a state in which the image is output on the TV screen, using a multi touch through a touch pad, both hands need to be used, which makes a user feel cumbersome. In other words, it is cumbersome to hold a remote controller with one hand and perform a multi touch with the other hand.

As described above, the remote controller using a touch pad has various kinds of inconveniences.

### DISCLOSURE

### Technical Problem

The present invention provides a remote controller having a dual touch pad that provides a user environment in which easy and convenient use of the remote controller is ensured, and a method of control using the same.

The present invention provides a remote controller having a dual touch pad that allows a text to be easily entered by using the touch pad, and a method of control using the same.

The present invention provides a remote controller having a dual touch pad that provides a stable touch sensibility at the time of a text entry, and based on the stable touch sensibility, allows a user to precisely recognize the text entry through a tactile sensation of a finger, and a method of control using the same.

The present invention provides a remote controller having a dual touch pad that allows a menu, a photo, or a list to be rapidly searched for and a method of control using the same.

The present invention provides a remote controller having a dual touch pad that allows an object being output on a screen to be easily enlarged, reduced or moved to front, rear, left and right sides using one hand, and a method of control using the same.

### Technical Solution

According to an aspect of the present invention, there is provided a remote controller including a communication unit, a first touch pad, a second touch pad, an elastic layer, a position sensing unit and a control unit. The communication unit may perform a communication with a control target device. The first touch pad may output a first selection signal to control the control target device. The second touch pad may be installed adjacent to the first touch pad and may output a second selection signal to control the control target device. The elastic layer may be formed on each of upper surfaces of the first touch pad and the second touch pad to provide a touch sensibility when the first touch pad and the second touch pad are pressed. The position sensing unit may sense whether the first touch pad and the second touch pad are positioned in a longitudinal direction or in a traverse direction and may output a third selection signal. The control unit may receive at least one of the first to third selection signals from the first touch pad, the second touch pad or the position sensing unit, and may transmit a control signal to the control target device.

The control unit, upon receiving the third selection signal indicating the sensing of the first touch pad and the second touch pad being positioned in a traverse direction from the position sensing unit, may transmit a third control signal corresponding to the third selection signal to the control target device to control the control target device such that a text entry box is output on a screen of the control target device.

A key pad call bar may be displayed at a lower side of a screen of the text entry box displayed on the control target device. When the key pad call bar is dragged up by using one of the first touch pad and the second touch pad, the control unit may receive a drag up signal from one of the first touch pad and the second touch pad, and may transmit the drag up signal to the control target device to control the control target device such that a size of the text entry box is reduced and a virtual key pad is displayed at a lower side of the text entry box.

The control unit, prior to a contact of an object with respect to the first touch pad and the second touch pad, may control the control target device to display a position of a finger on the virtual key pad. When the object makes contact with at least one of the first touch pad and the second touch pad, the control unit may control the control target device to display the position of the finger on a key of the virtual key pad corresponding to a position at which the object makes the contact, and may control the control target device to pre-select the key. When the object making contact with one of the first touch pad and the second touch pad applies a pressure, the control unit may control the control target device to display a symbol corresponding to the pre-selected key on the text entry box.

The control unit, prior to a contact of an object with respect to the first touch pad and the second touch pad, may control the control target device to display positions of two fingers on the virtual key pad so as to correspond to the first touch pad and the second touch pad, respectively, and when the object making contact with one of the first touch pad and the second touch pad moves, the control unit may control the control target device to move the position of the finger along a line of the movement of the object and to display the position of the finger on the virtual key pad.

The text entry box may include an internet search box, a phone number search box, an address search box, a URL search box, a program search box or a memo pad.

Four direction keys may be displayed on the first touch pad and the second touch pad, and in a state in which a plurality of items are arranged and displayed on a screen of the control target device, when a pressure pressing one of the four direction keys corresponding to a direction in which the plurality of items are arranged is sensed and the sensed pressure is output to the control unit, the control unit may transmit the selected direction key and movement speed of a cursor selecting one of the plurality of items according to the pressing pressure to the control target device to control the control target device such that the cursor is moved along the plurality of items at the movement speed.

The control unit may control the control target device to display the movement speed of the cursor on the screen of the control target device according to the pressing pressure.

The elastic layer may include silicon, rubber, fabric, leather, metal or a film-shaped pack sealed with liquid.

The remote controller may further include a distance sensing unit installed between the first touch pad and the second touch pad and configured to sense a distance with a first object positioned between the first touch pad and the second touch pad and movements of the first object in up and down or front, rear, left and right directions to output a fourth selection signal. The control unit, upon receiving the fourth selection signal from the distance sensing unit, may transmit a fourth control signal corresponding to the fourth selection signal to the control target device to control the control target device such that a second object being output on a screen of the control target device is enlarged, reduced or moved in front, rear, left and right directions.

According to another aspect of the present invention, there is provided a method of control using a remote controller having a dual touch pad including a first touch pad and a second touch pad adjacent to the first touch pad, the method including: sensing whether the dual touch pad is positioned in a longitudinal direction or in a traverse direction, by the remote controller; and if the dual touch pad is positioned in a traverse direction, controlling a control target device to output a text entry box on a screen of the control target device, by the remote controller.

The method may further include, after the outputting of the text entry box, controlling the control target device to reduce a size of the text entry box and to display a virtual key pad at a lower side of the text entry box when a key pad call bar provided at a lower side of a screen of the text entry box is dragged up through the dual touch pad, by the remote controller.

The method may further include, after the outputting of the virtual key pad, prior to a contact of an object with respect to the first touch pad and the second touch pad, controlling the control target device to display a position of a finger on the virtual key pad, by the remote controller, when the object makes contact with at least one of the first touch pad and the second touch pad; controlling the control target device to display the position of the finger on a key of the virtual key pad corresponding to a position at which the object makes the contact, by the remote controller, and controlling the control target device to pre-select the key; and when the object making contact with one of the first touch pad and the second touch pad applies a pressure, the remote controller controlling the control target device to display a symbol corresponding to the pre-selected key on the text entry box, by the remote controller.

According to another aspect of the present invention, there is provided a method of control using a remote controller having a dual touch pad including a first touch pad and a second touch pad adjacent to the first touch pad in which four direction keys are displayed on one of the first touch pad and the second touch pad, the method including: when one of the four direction keys is pressed, sensing a pressure of the direction key being pressed, by the remote controller; and transmitting movement speed of a cursor selecting one of the plurality of items displayed on a screen of a control target device according to the pressing pressure to the control target device to control the control target device to move the cursor along the plurality of items at the movement speed, by the remote controller.

In the controlling of the control target device, the remote controller may control the control target device to display the movement speed of the cursor on the screen of the control target device according to the pressing pressure.

### Advantageous Effects

According to the above-described aspects of the present invention, the remote controller has a dual touch pad and an elastic layer is formed on a surface of the touch pad, thereby providing a user environment that ensures easy and convenient use.

In other words, while watching a TV by use of the dual touch pad, a user checks the position, at which a finger is placed, on a virtual key pad of a TV screen, displays the position of the finger on a key of the virtual key pad corresponding to a motion of the finger for a desired text, and selects the corresponding key by using a pressure pressing with the finger, so that a text is easily entered using the dual touch pad.

Also, an elastic layer is formed on a surface of the dual touch pad, so that a stable touch sensibility is provided when the dual touch pad is pressed with a finger. Accordingly, the dual touch pad provides a stable touch sensibility at the time of a text entry, and based on the stable touch sensibility, allows a user to precisely the text entry through a tactile sensation of the finger.

Also, the remote controller according to the present invention provides a movement speed proportionate to a pressure of a finger pressing the dual touch pad, so that a menu, a photo or an item of a list can be rapidly searched for.

Also, the remote controller according to the present invention is provided with a distance sensing unit that is installed in between the dual touch pad to recognize up and down or front, rear, left and right movements of a finger, so that while holding the remote controller with one hand, reduction, enlargement or front, rear, left and right movements of an object can be intuitively performed through up and down movement of the finger above the distance sensing unit.

### DESCRIPTION OF DRAWINGS

FIG. 1 is a drawing illustrating a system including a remote controller having a dual touch pad according to an embodiment of the present invention.

FIG. 2 is a drawing illustrating an example of the system shown in FIG. 1.

FIG. 3 is a perspective view illustrating the remote controller having the dual touch pad shown in FIG. 2.

FIGS. 4 and 5 are drawings illustrating an operation of pressing a surface of the dual touch pad with a finger.

FIGS. 6 to 9 are drawings illustrating an example of text entry by using the remote controller shown in FIG. 3.

FIGS. 10 and 11 are drawings illustrating an example of VOD list search by using the remote controller shown in FIG. 3.

FIGS. 12 to 14 are drawings illustrating an example of image enlargement and reduction by using the remote controller shown in FIG. 3.

### MODE FOR INVENTION

In describing the present invention, detailed descriptions that are well-known but are likely to make the subject matter of the present invention unclear will be omitted in order to avoid redundancy.

It will be understood that terms used in the specification and the claims, such as those defined in commonly used dictionaries, should be interpreted as having a meaning that is consistent with their meaning in the context of the relevant art. Therefore, it should be understood that the embodiments described in the specification and the elements shown in the drawings are illustrative rather than restrictive, and the present invention covers all such modifications provided they come within the scope of the appended claims and their equivalents, as well as other embodiments.

Hereinafter, exemplary embodiments of the present invention will be described in detail with reference to the accompanying drawings.

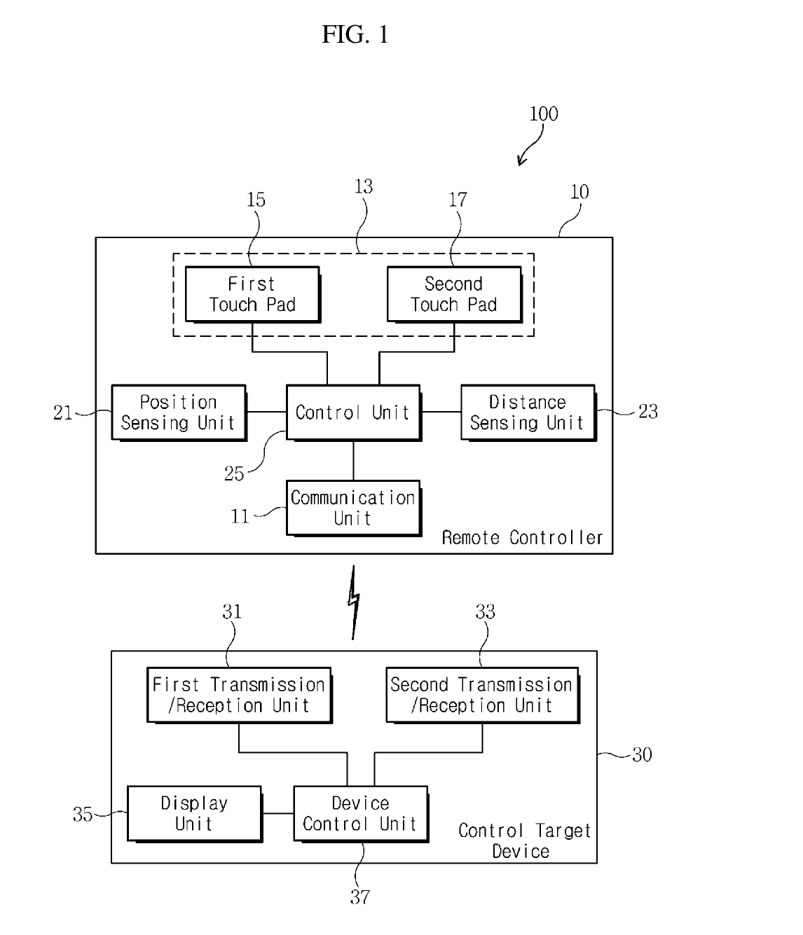

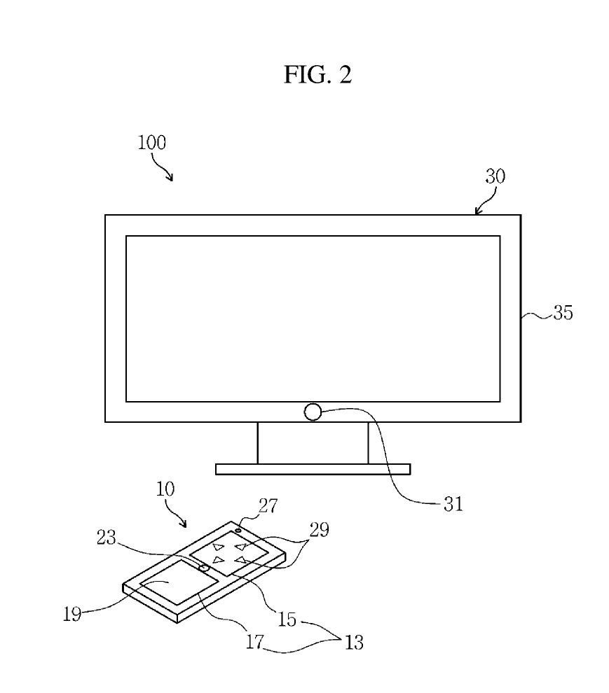

FIG. 1 is a drawing illustrating a system including a remote controller having a dual touch pad according to an embodiment of the present invention. FIG. 2 is a drawing illustrating an example of the system shown in FIG. 1.

Referring to FIGS. 1 and 2, a system 100 according to an embodiment of the present invention includes a remote controller 10 having a dual touch pad 13 and a control control target device 30 that is controlled by the remote controller 10.

The remote controller 10 sends the control target device 30 a control signal required for control of the control target device 30. The remote controller 10 is provided with the dual touch pad 13 that receives a user's touch and transmits a control signal.

The control target device 30 outputs various contents through an image or a sound according to the control signal received from the remote controller 10. The control target device 30 may provide various contents, such as internet connection, web surfing, VOD viewing, social network service (SNS), and games, according to the control of the remote controller 10. The control target device 30 may be implemented using an IPTV and a smart TV, but the implementation of the control target device 30 is not limited thereto.

Hereinafter, the remote controller 10 according to an embodiment of the present invention will be described in detail. The remote controller 10 includes a communication unit 11, a dual touch pad 13, an elastic layer 19, a position sensing unit 21 and a control unit 25, and may further include a distance sensing unit 23.

The communication unit 11 performs a communication with the control target device 30 according to control of the control unit 25. The communication unit 11 may use a short distance communication as a communication method. For example, the short distance communication may be implemented using an infrared communication, a bluetooth communication. However, the implementation of the communication method is not limited thereto.

The dual touch pad 13 generates a selection signal according to a user's touch, and transmits the generated selection signal to the control unit 25. The dual touch pad 13 includes a first touch pad 15 and a second touch pad 17. The first touch pad 15 outputs a first selection signal to control the control target device 30. The second touch pad 17 is installed adjacent to the first touch pad 15 and outputs a second selection signal to control the control target device 30. The first and second touch pads 15 and 17 sense a pressure according to a user's touch to generate a selection signal. The first and second touch pads 15 and 17 may generate a different selection signal depending on the intensity of a pressure according to a user's touch. In this case, the control unit 25 transmits a first control signal and a second control signal corresponding to the received first selection signal and second selection signal to the control target device 30. Depending on the first control signal or the second control signal, the control unit 25 provides various signals required for controlling the control target device 30, so that a user enjoys various contents, such as text entry, web surfing, broadcasting program search and selection, and SNS, through the dual touch pad 13.

On the first touch pad 15, four direction keys 29 may be displayed. The four direction keys 29 operate when a plurality of items are arranged on a screen of the control target device 30. A user may search for and select a desired item through a touch of the four direction keys 29. The four direction keys 29 may be formed on an upper surface of the first touch pad 15, or may be formed on the elastic layer 19. Meanwhile, the above description is made in relation that the four direction keys 29 are displayed on the first touch pad 15 as an example, but four direction keys may be displayed on the second touch pad 17.

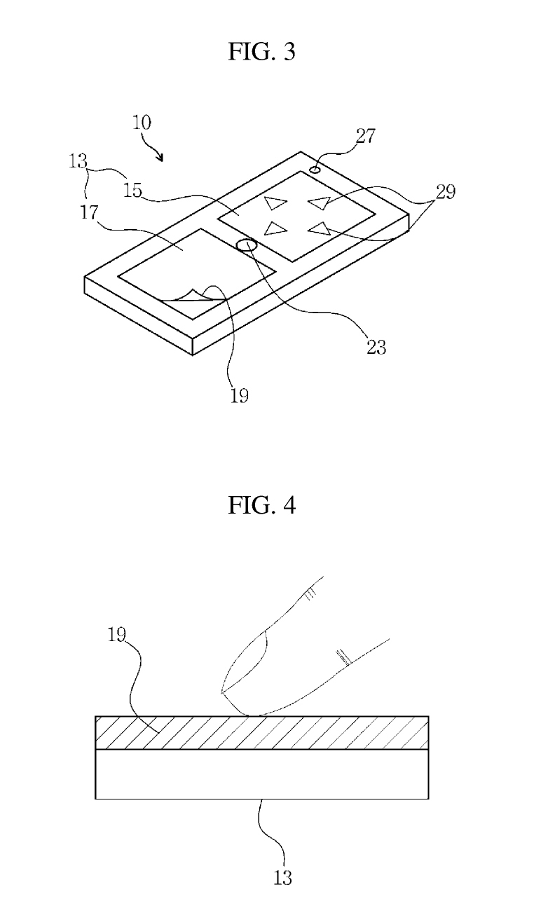

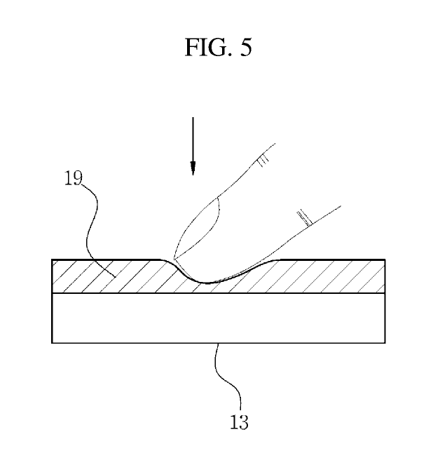

Referring to FIGS. 3 to 5, the elastic layer 19 is formed on each of upper surfaces of the first touch pad 15 and the second touch pad 17 to provide a user with a stable touch sensibility when the first and second touch pads 15 and 17 are pressed. For example, the elastic layer 19 may be implemented using material that is pressed by a user with a user's finger or a pen to provide the user with a touch sensibility while being deformed in the pressing direction, for example, silicon, rubber, fabric, leather or metal. In addition, the elastic layer 19 may be provided as a film-shaped pack sealed with a liquid, such as glycerin.

As for the general touch pad, there is a problem in that, a portion to be touched is hard, so the touch sensibility is lowered. Meanwhile, according to an embodiment of the present invention, the elastic layer 19 is formed on each of the surfaces of the first and second touch pads 15 and 17, thereby providing a user with more precise and stable touch sensibility.

The position sensing unit 21 senses whether the first and second touch pads 15 and 17 are positioned in a longitudinal direction or a traverse direction to output a third selection signal. That is, the position sensing unit 21 senses whether the remote controller 10 is positioned in a longitudinal direction or a traverse direction to output a third selection signal to the control unit 25. The position sensing unit 21 may be implemented using a gyroscope sensor, a gravity sensor, an accelerometer sensor, and a terrestrial magnetism sensor, but the implementation of the position sensing unit 21 is not limited thereto. The control unit 25 transmits a third control signal corresponding to the received third selection signal to the control target device 30. According to the third control signal, a text entry box may be output on the screen of the control target device 30.

The text entry box may include an internet search box, a phone number search box, an address search box, a URL search box, a program search box or a memo pad, but the implementation of the text entry box is not limited thereto.

The distance sensing unit 23 is installed between the first touch pad 15 and the second touch pad 17, and configured to sense a distance from an object (for example, a finger, a pen) positioned between the first touch pad 15 and the second touch pad 17 and sense up and down or front, rear, left and right movements of the object to output a fourth selection signal. In other words, the distance sensing unit 23 may sense a distance from an object positioned above the distance sensing unit 23 and a positional change in space to output a fourth selection signal. The positional change of the object in space with respect to the distance sensing unit 23 represents a positional change of an object in up and down or front, rear, left and right directions with respect to the distance sensing unit 23. The distance sensing unit 23 may be implemented using an optical sensor, a capacitive sensor, a ultrasonic sensor, and an infrared sensor, but the implementation of the distance sensing unit is not limited thereto. The object may represent a user's finger or a pen. The control unit 25 transmits a fourth control signal corresponding to the received fourth selection signal to the control target device 30. For example, according to the fourth control signal, an enlargement or a reduction may be performed on an image that is output on the screen of the control target device 30. Alternatively, according to the fourth control signal, front, rear, left and right direction movements may be performed on an object that is output on the screen of the control target device 30, for example, on an image or a menu.

In addition, the control unit 25 is implemented using a microprocessor that performs an overall control operation of the remote controller 10, and configured to provide various control signals to control the target object 30. In other words, the control unit 25 receives at least one of the first to fourth selection signals from the first touch pad 15, the second touch pad 17, the position sensing unit 21 or the distance sensing unit 23, and transmits a control signal corresponding to the received selection signal to the control target device 30.

The control unit 25 may perform a text entry as follows.

That is, the control unit 25, upon receiving the third selection signal indicating the sensing of the first touch pad 15 and the second touch pad 17 being positioned in a traverse direction from the position sensing unit 21, transmits a third control signal corresponding to the third selection signal to the control target device 30 to control the control target device 30 such that a text entry box is output on the screen of the control target device 30.

In this case, a key pad call bar is displayed at a lower side of a screen of the text entry box displayed on the control target device 30. When the key pad call bar is dragged up by using one of the first touch pad 15 and the second touch pad 17, the control unit 25 receives a drag up signal from one of the first touch pad 15 and the second touch pad 17, and transmits the drag up signal to the control target device 30 such that a size of the text entry box is reduced and a virtual key pad is displayed at a lower side of the text entry box.

The control unit 25 may control the control target device 30 to display a position of a finger on the virtual key pad, prior to a contact of an object with respect to the first touch pad 15 and the second touch pad 17.

When the object makes contact with at least one of the first touch pad 15 and the second touch pad 17, the control unit 25 may control the control target device 30 to display a position of the finger on a key of the virtual key pad corresponding to a position at which the object makes the contact, and control the control target device 30 to pre-select the key.

When the object making contact with one of the first touch pad 15 and the second touch pad 17 applies a pressure, the control unit 25 controls the control target device 30 display a symbol correspond to the pre-selected on the text entry box.

In this case, the position of the finger displayed on the virtual key pad may be displayed using a pointer, a cursor, a highlight and a virtual finger. The control unit 25 may control the control target device 30 to display positions of two fingers on the virtual key pad so as to correspond to the first touch pad 15 and the second touch pad 17, respectively, prior to a contact of an object with respect to the first touch pad 15 and the second touch pad 17. When the object making contact with one of the first touch pad 15 and the second touch pad 17 moves, the control unit 25 may control the control target device 30 to move the position of the finger along a line of the movement of the object and display the moved position on the virtual keypad.

As described above, a user may perform a text entry by performing contact, movement and pressing operations on the first and second touch pads 15 and 17 using an index finger while holding the remote controller 10 with two hands, so that the text entry can be performed while watching the virtual keypad.

In addition, the control unit 25 may perform an item search as follows.

That is, when a plurality of items are arranged and displayed on the screen of the control target device 30 and the first touch pad 15 senses a pressure pressing one of the four direction keys 29 of the first touch pad 15 corresponding to a direction in which the plurality of items are arranged, the first touch pad 15 sends the control unit 25 information about one of the four direction keys being selected and the pressure pressing the selected direction key.

The control unit 25 transmits the selected direction key and a movement speed of a cursor that selects one of the plurality of items according to the applied pressure to the control target device 30 such that the cursor moves along the plurality of items at the corresponding movement speed. The moving direction of the cursor corresponds to a direction of the direction key.

In this case, in order for a user to check the movement speed of the cursor according to the applied pressure, the control unit 25 may control the control target device 30 to display the movement speed on the screen of the control target device 30.

In addition, the control unit 25 may perform an enlargement or reduction on an image displayed on the screen of the control target device 30.

When an image is displayed on the screen of the control target device 30, the distance sensing unit 23 senses a distance from an object positioned above the distance sensing unit 23 to output a fourth selection signal to the control unit 25.

The control unit 25, upon receiving the fourth selection signal from the distance sensing unit 25, transmits a fourth control signal corresponding to the fourth selection signal to the control target device 30 to control the control target device 30 such that an image output on the screen of the control target device 30 is enlarged or reduced. For example, when the object moves toward the distance sensing unit 23, the image may be reduced, and when the object moves away from the distance sensing unit 23, the image may be enlarged. On the contrary, when the object moves toward the distance sensing unit 23, the image may be enlarged, and when the object moves away from the distance sensing unit 23, the image may be reduced.

In addition, the control unit 25, by sensing front, rear, left and right direction movements of the object positioned above the distance sensing unit 23, may output a fourth selection signal to the control unit 25. In a state in which an image is output on the screen, the control unit 25, upon receiving the fourth selection signal from the distance sensing unit 23, transmits a fourth control signal corresponding to the fourth selection signal to the control target device 30 to control the control target device 30 such that the image output on the screen of the control target device 30 is moved in front, rear, left and right directions. In a state in which a menu is output on the screen, the control unit 25, upon receiving the fourth selection signal from the distance sensing unit 23, transmits a fourth control signal corresponding to the fourth selection signal to the control target device 30 to control the control target device 30 such that the menu output on the screen of the control target device 30 is moved in front, rear, left and right directions.

In addition, the remote controller 10 according to an embodiment of the present invention may be further provided with an on/off button 27 to turn on and turn off the control target device 30. In this case, the on/off button 27 may be disposed on an upper surface of the remote controller 10 on which the dual touch pad 13 is installed. For example, the on/off button 27 may be disposed on an outer side of the first touch pad 15, that is, a front side of the remote controller 10.

Meanwhile, the description according to an embodiment of the present invention is made in relation that the on/off button 27 is disposed on an upper surface of the remote controller 10, but the disposition of the on/off button is not limited thereto. For example, the on/off button 27 may be disposed at a lateral surface or a lower surface of the remote controller 10.

Hereinafter, the control target device 30 according to an embodiment of the present invention will be described in detail. The control target device 30 includes a first transmission/reception unit 31, a second transmission/reception unit 33, a display unit and a device control unit 37.

The first transmission/reception unit 31 performs a communication with the remote controller 10 according to the device control unit 37. The first transmission/reception unit 31 may use a short distance communication as a communication method. For example, the short distance communication may be implemented using an infrared communication, a bluetooth communication. However, the implementation of the communication method of the first transmission/reception unit 31 is not limited thereto. The first transmission/reception unit 31 uses the same short distance communication method as that of the communication unit 11.

The second transmission/reception unit 33 is a communication device used to access an external network, such as the internet. The second transmission/reception unit 33 transmits and receives information required for providing contents, such as broadcasting programs, web, VOD, SNS, and games, according to the control of the device control unit 37.

The display unit 35 outputs various images including various function menus that are executed on the control target device 30. The display unit 35 outputs an image required during execution of a text entry box, a broadcasting program, applications, web, VOD, SNS, and games. In this case, the display unit 35 may be implemented using various display devices, such as a liquid crystal display (LCD), an organic light emitting diode (OLED), a touch screen.

In addition, the device control unit 37 is implemented using a microprocessor performing an overall control operation of the control target device 30, and configured to operate according to a control signal received from the remote controller 10. For example, the device control unit 37 may output a text entry box on the display unit 35 to enter a text, performs an item search, or enlargement or reduction of an image output on the display unit 35.

As described above, the remote controller 10 according to an embodiment of the present invention is provided with the dual touch pad 13, and the elastic layer 19 is formed on a surface of the dual touch pad 13, thereby providing a user environment that ensures easy and convenient use. In other words, a user, while watching a TV, checks the position, at which a finger is placed, on the virtual key pad on the TV screen, and displays the finger position on a key of the virtual key pad corresponding to a movement of a finger for a desired text, through the dual touch pad 13. Since the key is selected by using a pressure pressing the dual touch pad 13 with a finger, the text is easily entered using the dual touch pad 13.

In addition, since the elastic layer 19 is formed on the surface of the dual touch pad 13, a stable touch sensibility is provided when the dual touch pad 13 is pressed with a finger. Accordingly, the dual touch pad 13 provides a stable touch sensibility at the time of text entry, thus a user precisely recognizes the text entry through a tactile sensation of the finger.

In addition, the remote controller 10 according to an embodiment of the present invention provides a movement speed proportionate to the intensity of a pressure of a finger pressing the dual touch pad 13, thereby rapidly searching for menus, photos, or lists.

In addition, the remote controller 10 according to an embodiment of the present invention is provided with the distance sensing unit 23 installed in between the dual touch pad 13 to recognize up and down direction movements of a finger, so that a user may intuitively perform a reduction or enlargement on an image through up and down movements of a finger above the distance sensing unit 23 while holding the remote controller 10 with one hand.

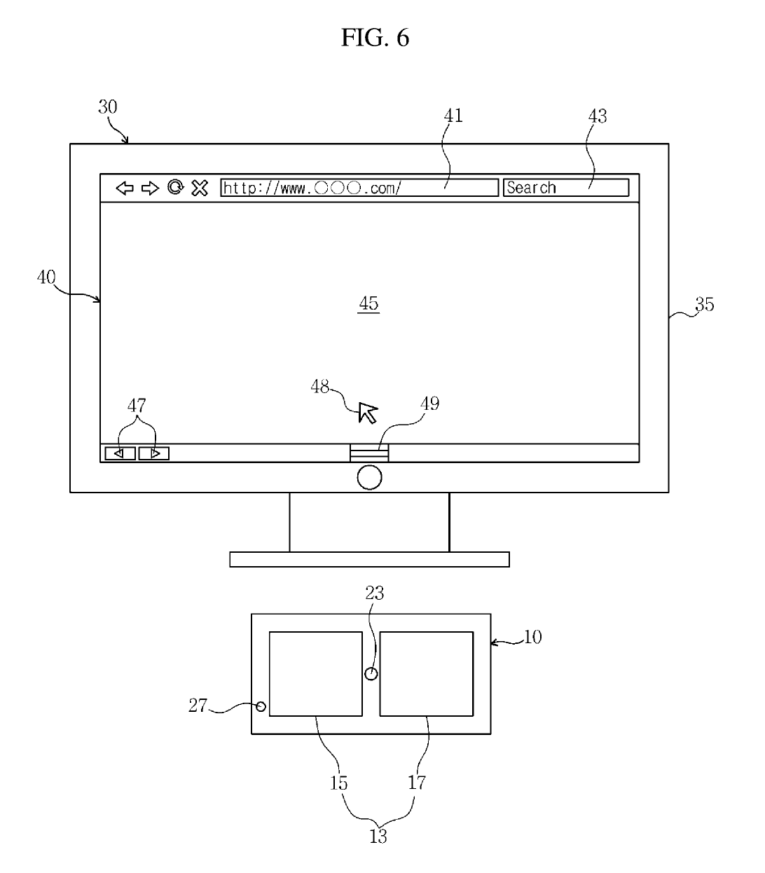

Hereinafter, an example of the text entry using the remote controller 10 according to an embodiment of the present invention will be described with reference to FIGS. 6 to 9. FIGS. 6 to 9 are drawings illustrating an example of text entry using the remote controller 10 shown in FIG. 3.

First, the remote controller 10 senses whether the dual touch pad 13 is positioned in a longitudinal direction or in a traverse direction through the position sensing unit.

Referring to FIG. 6, the remote controller 10, upon sensing that the dual touch pad 13 is positioned in a traverse direction, controls the control target device 30 to output a text entry box 40 on the screen of the control target device 30. The text entry box 40 is illustrated as an internet search box output on the screen of the control target device. The text entry box 40 is provided at an upper portion thereof with a URL input box 41 and a search word input box 43, and at a lower portion thereof with a movement button 47 for moving to a previous screen or a next screen and a key pad call bar 49. The text entry box 40 is provided at the center thereof with an information output box 45 to display a screen according a URL address entered into the URL input box 41. In the text entry box 40, a pointer 48 is displayed so as to be moved by the dual keypad 13.

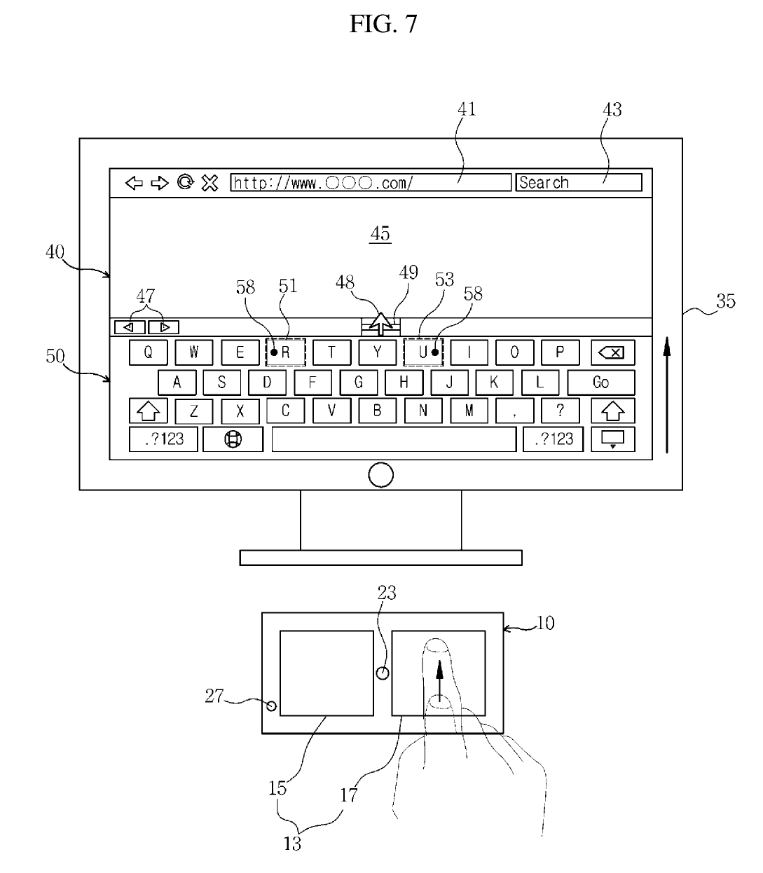

Referring to FIG. 7, when the key pad call bar 49 provided at a lower side of the screen of the txt input box 40 is dragged up through the dual touch pad 13, the remote controller 10 controls the control target device 30 to reduce the size of the text entry box 40 and to display a virtual keypad 50 at a lower side of the text entry box 40. In detail, the pointer 48 is positioned on the key pad call bar 49 through a contact and a movement with respect to the dual touch pad 13. Then, a predetermined pressure is applied to the dual touch pad 13 to select the key pad invocation bar 49, and in this state, the key pad call bar 49 is dragged up.

In this case, the remote controller 10 controls the control target device 30 to display a position of a finger on the virtual key pad 50, prior to a contact of an object with respect to the first touch pad 15 and the second touch pad 17. That is, in order to express a movement according to contact of a finger with respect to the first and second touch pads 15 and 17, finger tracking pointers 58 corresponding to the first and second touch pads 15 and 17 may be simultaneously displayed. In this case, the finger tracking pointers 58 may be implemented in various shapes, such as a dot, a finger, a ball or an arrow. According to an embodiment of the present invention, the finger tracking pointer 58 is provided in the form of a dot. The finger tracking pointers 58 may be displayed in different shapes, respectively, so that a user easily distinguishes a left finger and a right finger from each other.

In addition, among a plurality of keys included in the virtual keypad 50, one key at the left side and another one key at the right side may be highlighted and displayed. According to an embodiment of the present invention, an “R” key 51 and an “U” key 53 are highlighted as an example. The object is illustrated as a finger of the left hand and a finger of the right hand, but the implementation of the object is not limited thereto.

Meanwhile, if a touch input through the first and second touch pads 15 and 17 is performed on the outside of the virtual key pad 50, for example, positioned on the text entry box 40, the finger tracking pointers 58 may be displayed or changed into a single pointer 48 and displayed.

Meanwhile, referring to FIG. 7, the finger tracking pointers 58 are displayed together with a single pointer 48 configured to drag up the key pad call bar 49 for convenience sake of use, but after the drag-up, the single pointer 48 may disappear and only the finger tracking pointers 58 may be displayed. Alternatively, after the drag-up, the single pointer 48, if moving to a region of the virtual key pad 50, may be changed into the finger tracking pointer 58 and displayed.

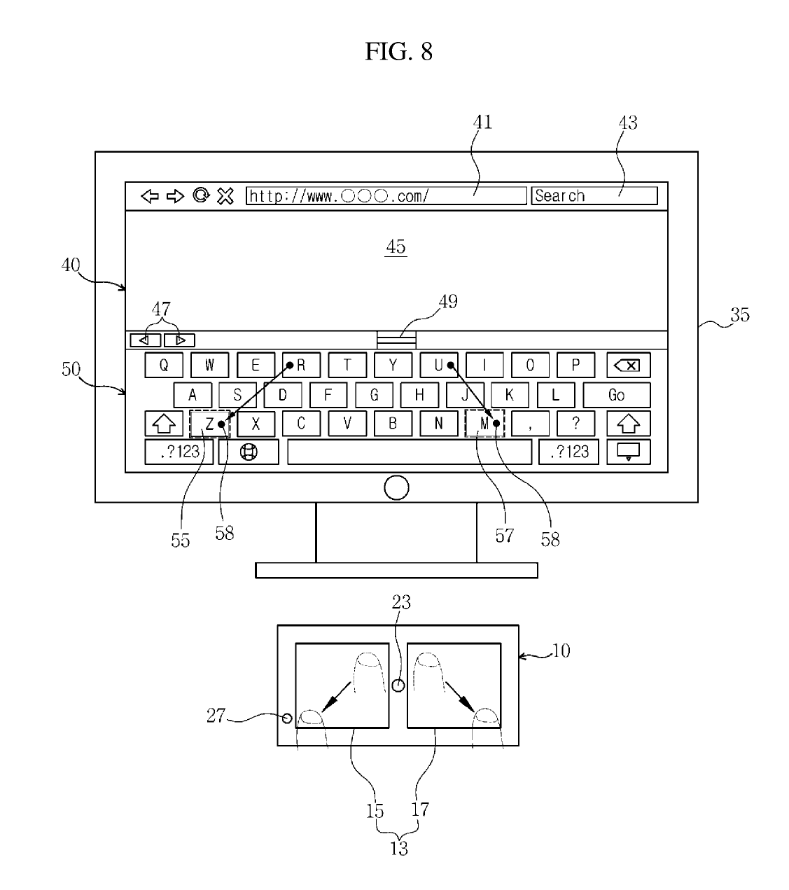

Referring to FIG. 8, the remote controller 10, when the objet makes contact with at least one of the first touch pad 15 and the second touch pad 17, controls the control target device 30 to highlight a key of the virtual key pad 50 corresponding to a position, at which the object makes the contact, and controls the control target device 30 to pre-select the corresponding key.

Then, upon movement of the object making contact with one of the first and second touch pads 15 and 17, the remote controller 10 controls the control target device 30 to move the finger tracking pointer 58 along a line of movement of the object and move the highlight position according to the moved position of the finger tracking pointer 58 such that a key at the moved position is highlighted on the virtual key pad 50. That is, when the finger moves while in contact with the first and second touch pads 15 and 17, the finger tracking pointer 58, while moving, highlights and displays a key selected according to the moving path of the finger. The highlighted display of the previously selected key is canceled. For example, if pre-selected keys are changed from the “R” key and the “U” key to a “Z” key 55 and an “M” key 57, the control target device 30 cancels the highlighted display of the “R” key and the “U” key, and highlights the “Z” key 55 and the “M” key 57.

Meanwhile, the finger tracking pointer 58 moves in connection with the movement of the finger making contact with the first and second touch pads 15 and 17, so that if only one of the fingers that make contact with the first and second touch pads 15 and 17 moves, only one of the finger tracking pointers 58 corresponding to the moving finger moves and the other finger tracking pointer may not move. As in this embodiment of the present invention, when both fingers making contact with the first and second touch pads 15 and 17 simultaneously move, both of the finger tracking pointers 58 may move.

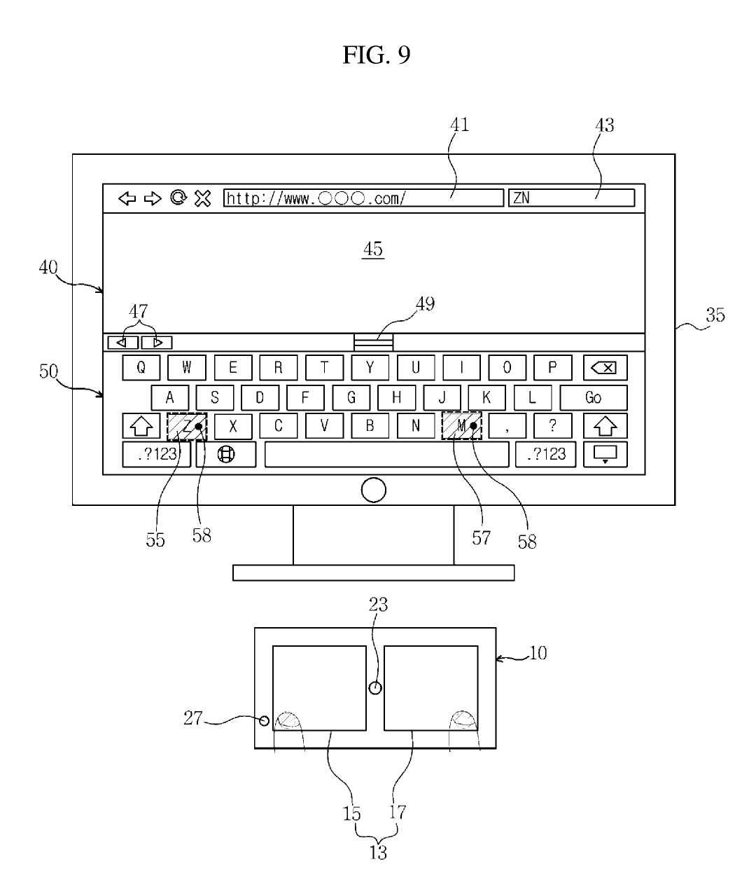

Referring to FIG. 9, when an object making contact with one of the first and second touch pads 15 and 17 applies a pressure, the remote controller 10 controls the control target device 30 to display a symbol according to the pre-selected key on the text entry box 40. For example, when the pre-selected “Z” key 55 and “M” key 57 are sequentially pressed, the control target device 30 displays “ZM” on the search box 43 of the text entry box 40 according to a control signal of the remote controller 10.

Then, the control target device 30 may display a text corresponding to “ZM” on the information output box 45 so as to be distinguished from other information displayed on the information output box 45. If the information output box 45 does not have a text corresponding to “ZM”, a message notifying that the corresponding text is not found may be output.

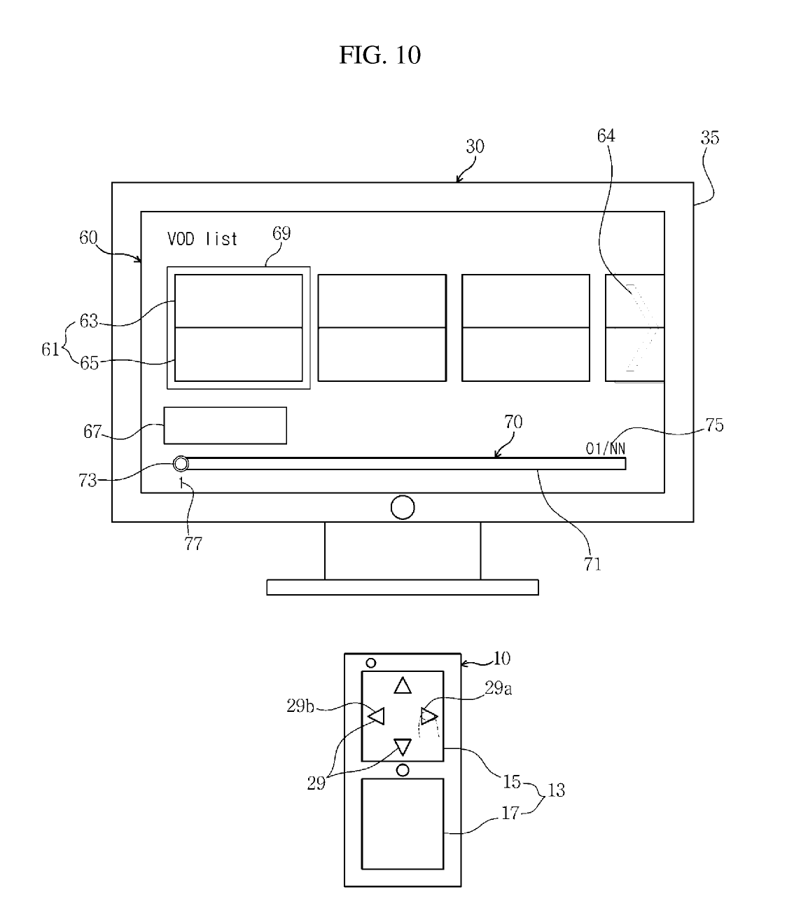

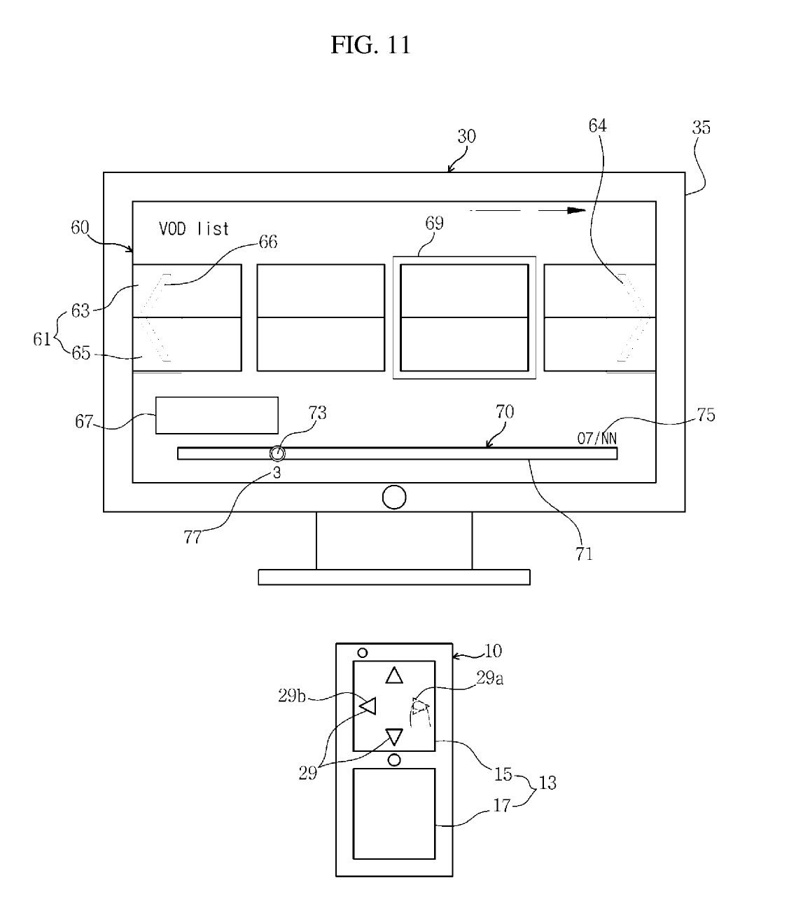

Referring to FIGS. 10 and 11, an example of a VOD list search using the remote controller 10 according to an embodiment of the present invention will be described. FIGS. 10 and 11 are drawings illustrating an example of VOD list search by using the remote controller 10 shown in FIG. 3.

Referring to FIG. 10, a VOD list 60 is displayed on the screen of the control target device 30. A plurality of VOD items included in the VOD list 60 are displayed in a traverse direction. If all of the VOD items 61 included in the VOD list 60 are not displayed on the single screen, a movement key 64 may be displayed at the right side or left side of the screen. The screen displays the VOD items 61 starting from the first VOD item, and the movement key 64 is illustrated only at the right side (referred to as a right movement key 64). The displaying of the right side movement key 64 represents the existence of more VOD items 61 that are hidden in a direction of the right movement key 64.

In this case, the VOD item 61 displays a thumb nail 63 according to a representative image and program information 65 of a VOD. The thumb nail 63 may be provided in the form of a still image or a moving image of the corresponding VOD. The program information 65 of a VOD represents summary information about the corresponding VOD, for example, views, comments, program title, and uploaded date.

When a cursor 69 is positioned on one of the VOD items 61 displayed on the screen, additional program information 67 about the VOD item 61 at which the cursor 69 is positioned may be displayed at a lower side of the VOD item 61. The additional program information 67 may include a program title and a program genre (category) of the corresponding VOD.

In addition, information 70 according to the intensity of a pressure may be displayed at a lower portion of the screen. The information 70 according to the intensity of a pressure may display information 77 about the intensity of a pressure, the total number of VOD items 61, and information 71, 73 and 75 about the sequence number of a VOD item at which the cursor 69 is positioned. The information 77 about the intensity of pressure may be displayed in a plurality of levels, for example, “1” to “8”. As the pressure increases, the number of the level and the movement speed also increase. The information 71, 73 and 75 about the sequence number of a VOD items 61 may include a left and right movement bar 71, a movement button 73 moving along the left and right movement bar 71, and a sequence number 75.

The sequence number 75 may be displayed as “the sequence number of a VOD item 61 at which the cursor 69 is positioned/the total number of VOD items 61”. For example, referring to FIG. 10, the cursor 69 indicates the first VOD item, and the total number of the VOD items is NN, so that the sequence number 77 is displayed as “01/NN”. The information 77 about the intensity of pressure may be displayed adjacent to the movement button 73. The information 77 about the intensity of pressure may be illustrated as being displayed at an outside of the movement button 73, but the information 77 about the intensity of pressure may be displayed at an inside of the movement button 73.

When the VOD items 61 are arranged in a traverse direction, the VOD list 60 may be searched through a left direction key 29a and a right direction key 29b among the four side direction keys 29 so as to correspond to the traverse direction.

Prior to manipulation of the remote controller 10, referring to FIG. 10, the cursor 69 may be positioned at the first VOD item 61 of the VOD list 60. Alternatively, if the VOD list 60 has been previously searched, the cursor 69 may be positioned at the finally selected VOD item 61 in the past.

Referring to FIG. 11, when the right direction key 29a of the first touch pad 15 is pressed, the remote controller 10 senses the pressure pressing the right direction key 29a, and sends the control target device 30 movement speed of the cursor 69 in proportion to the sensed pressure.

Then, the control target device 30 moves the cursor 69 according to the received movement speed. According to an embodiment of the present invention, the cursor 69 is illustrated as moving to the seventh VOD item 61. Since the screen displays only some of the VOD items 61 up to the seventh VOD items 61, the left movement key 66 and the right movement key 64 are simultaneously displayed on the screen.

In this case, the information 77 about intensity of pressure is displayed as “3” at the lower portion of the screen, and the sequence number of the seventh VOD item 61 among NN VOD items 61 in total, at which the cursor 69 is positioned, is displayed as “07/NN”.

According to the existing technology, a desired item is selected by moving a cursor through a flicking of a touch pad, through an operation of sequentially pressing four direction keys. Accordingly, there is a problem in that if a desired item needs to be searched among a large number of items, a great amount of time is consumed.

However, the remote controller 10 according to an embodiment of the present invention enables a user to easily adjust the movement speed of the cursor 69 according to the intensity of a pressure pressing the four direction keys 29. Accordingly, the cursor 69 is rapidly moved to a position at which a desired item is positioned among a large number of items, to find out the corresponding item. Accordingly, as the remote controller 10 according to an embodiment of the present invention is used, the item search can be more rapidly performed compared to the conventional item search.

Meanwhile, the above example of a search of the VOD list 60 is illustrated as moving the cursor 69 according to a control signal of the remote controller 10, but the VOD item 61 may be moved in a state that the cursor 69 remains still. Alternatively, according to a control signal of the remote controller 10, the cursor 69 and the VOD item 61 may be simultaneously moved.

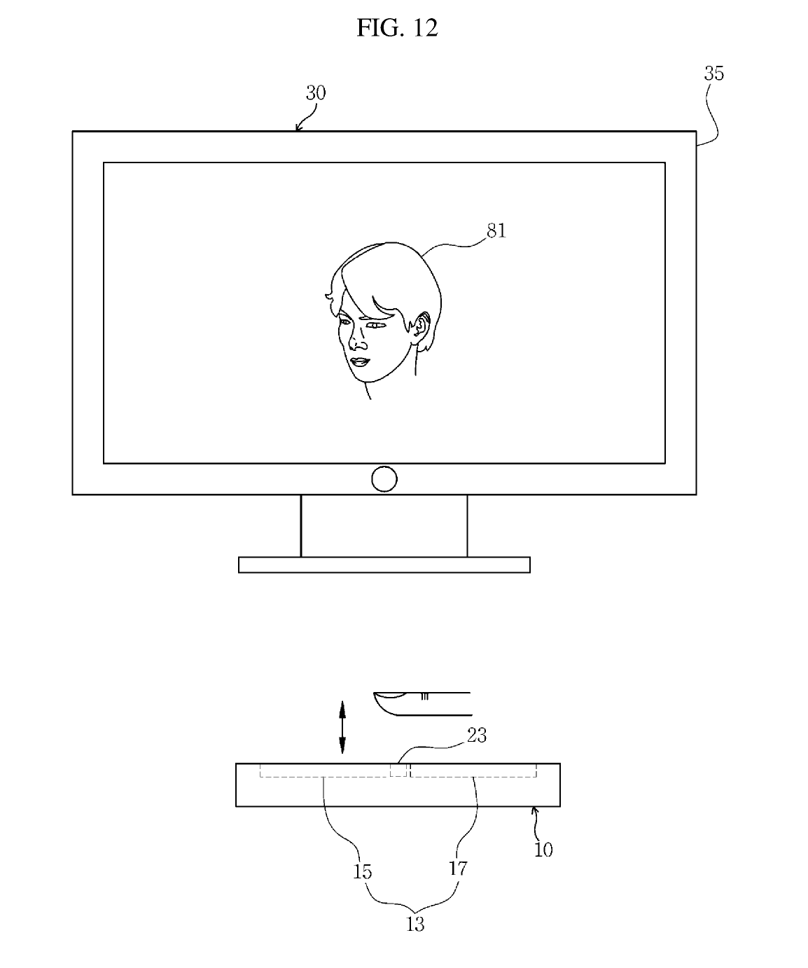

Hereinafter, an example of enlargement or reduction of an image by using the remote controller 10 according to an embodiment of the present invention will be described with reference to FIGS. 12 to 14. FIGS. 12 to 14 are drawings illustrating an example of image enlargement and reduction by using the remote controller 10 shown in FIG. 3.

Referring to FIG. 12, when an image 81 is displayed on the screen of the control target device 30, the remote controller 10 senses whether an object is positioned above the distance sensing unit 23. In order to sense whether an object is positioned above the distance sensing unit 23, the remote controller 10 senses whether an object is positioned above the distance sensing unit 23 for a predetermined period of time.

If the distance sensing unit 23 senses an object, the remote controller 10 prepares for transmission of a control signal that is required to enlarge or reduce the image 81 displayed on the screen of the control target device 30.

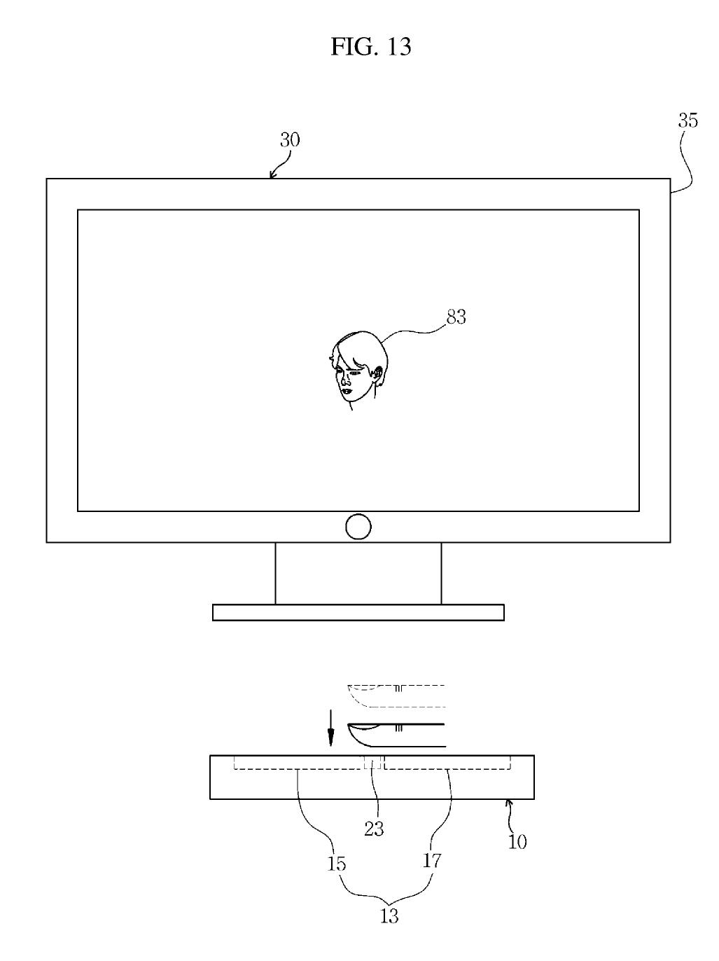

Then, referring to FIG. 13, when the object moves toward the distance sensing unit 23, the remoter controller 10 sends the control target device 30 a control signal to reduce the image 83 displayed on the screen of the control target device 30.

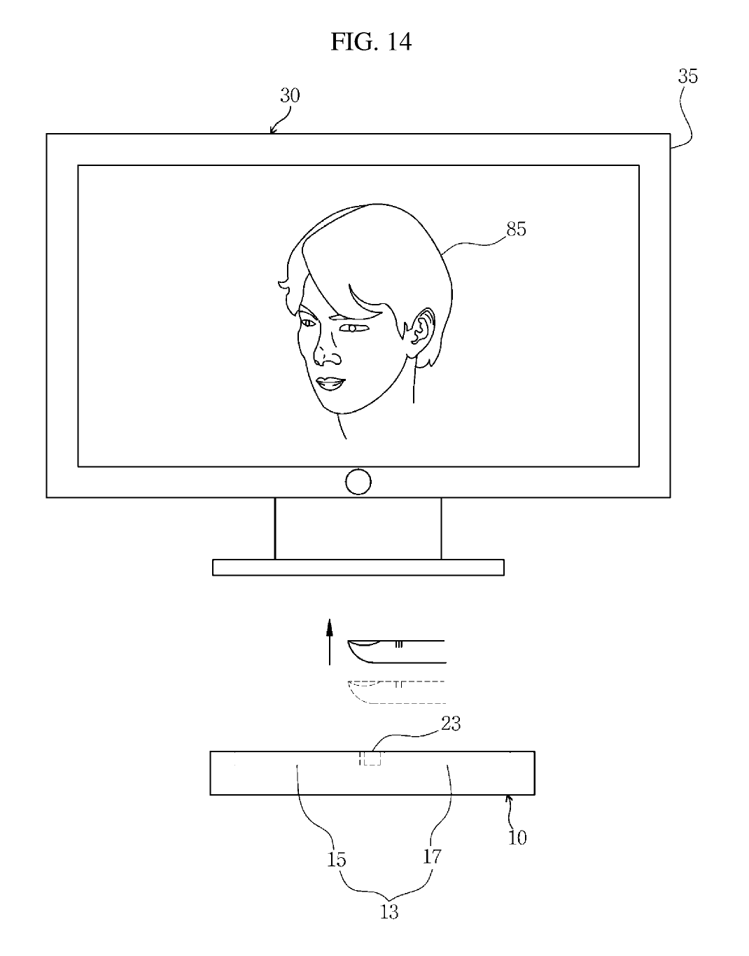

On the contrary, referring to FIG. 14, when the object moves away from the distance sensing unit 23, the remote controller 10 sends the control target device 30 a control signal to enlarge the image 85 displayed on the screen of the control target device 30.

According to the conventional technology, when an image displayed on the screen needs to be reduced or enlarged, the reduction or enlargement is performed through a multi touch of a touch pad, which requires a user to manipulate the remote controller with both hands, causing the user to feel cumbersome. In other words, a user, while holding a remote controller with one hand, needs to perform a multi touch with a finger of the other hand, so that the user needs to use both hands to reduce or enlarge an image.

However, according to an embodiment of the present invention, the distance sensing unit 23 is disposed between the first touch pad 15 and the second touch pad 17, so that image reduction or enlargement can be performed using a finger of a hand holding the remote controller 10, for example, a thumb. Since a user, while holding the remote controller 10 with one hand, can reduce or enlarge an image by moving the thumb up and down in a state in which the thumb is positioned above the distance sensing unit 23, thereby removing the inconvenience of using both hands as in the conventional technology.

In addition, upon occurrence of front, rear, left and right movements of the thumb with respect to the distance sensing unit 23, the control target device 30 may move the image being output on the screen according to a control signal of the remote controller 10.

The description suggests the best mode of the present invention to provide an example that explains the present invention and also enables one skilled in the art to manufacture and use the present invention. The specification drafted as such is not limited to detailed terms suggested in the specification. Accordingly, it will be apparent to those skilled in the art that various modifications, changes, and variations may be made in the example without departing from the scope of the invention.

1. A remote controller having a dual touch pad, comprising:
a communication unit configured to perform a communication with a control target device;
a first touch pad configured to output a first selection signal to control the control target device;
a second touch pad installed adjacent to the first touch pad and configured to output a second selection signal to control the control target device;
an elastic layer formed on each of upper surfaces of the first touch pad and the second touch pad to provide a touch sensibility when the first touch pad and the second touch pad are pressed;
a position sensing unit configured to sense whether the first touch pad and the second touch pad are positioned in a longitudinal direction or in a traverse direction and output a third selection signal; and
a control unit configured to receive at least one of the first to third selection signals from the first touch pad, the second touch pad or the position sensing unit, and transmit a control signal to the control target device.

2. The remote controller of claim 1, wherein the control unit, upon receiving the third selection signal indicating the sensing of the first touch pad and the second touch pad being positioned in a traverse direction from the position sensing unit, transmits a third control signal corresponding to the third selection signal to the control target device to control the control target device such that a text entry box is output on a screen of the control target device.

3. The remote controller of claim 2, wherein a key pad call bar is displayed at a lower side of a screen of the text entry box displayed on the control target device,
when the key pad call bar is dragged up by using one of the first touch pad and the second touch pad, the control unit receives a drag up signal from one of the first touch pad and the second touch pad, and transmits the drag up signal to the control target device to control the control target device such that a size of the text entry box is reduced and a virtual key pad is displayed at a lower side of the text entry box.

4. The remote controller of claim 3, wherein the control unit, prior to a contact of an object with respect to the first touch pad and the second touch pad, controls the control target device to display a position of a finger on the virtual key pad,
when the object makes contact with at least one of the first touch pad and the second touch pad, controls the control target device to display the position of the finger on a key of the virtual key pad corresponding to a position at which the object makes the contact, and controls the control target device to pre-select the key, and
when the object making contact with one of the first touch pad and the second touch pad applies a pressure, controls the control target device to display a symbol corresponding to the pre-selected key on the text entry box.

5. The remote controller of claim 4, wherein the control unit, prior to a contact of an object with respect to the first touch pad and the second touch pad, controls the control target device to display positions of two fingers on the virtual key pad so as to correspond to the first touch pad and the second touch pad, respectively, and
when the object making contact with one of the first touch pad and the second touch pad moves, controls the control target device to move the position of the finger along a line of the movement of the object and to display the position of the finger on the virtual key pad.

6. The remote controller of claim 2, wherein the text entry box includes an internet search box, a phone number search box, an address search box, a URL search box, a program search box or a memo pad.

7. The remote controller of claim 1, wherein four direction keys are displayed on the first touch pad and the second touch pad, and
in a state in which a plurality of items are arranged and displayed on a screen of the control target device, when a pressure pressing one of the four direction keys corresponding to a direction in which the plurality of items are arranged is sensed and the sensed pressure is output to the control unit, the control unit transmits the selected direction key and movement speed of a cursor selecting one of the plurality of items according to the pressing pressure to the control target device to control the control target device such that the cursor is moved along the plurality of items at the movement speed.

8. The remote controller of claim 7, wherein the control unit controls the control target device to display the movement speed of the cursor on the screen of the control target device according to the pressing pressure.

9. The remote controller of claim 1, wherein the elastic layer includes silicon, rubber, fabric, leather, metal or a film-shaped pack sealed with liquid.

10. The remote controller of claim 1, further comprising a distance sensing unit installed between the first touch pad and the second touch pad and configured to sense a distance with a first object positioned between the first touch pad and the second touch pad and movements of the first object in up and down or front, rear, left and right directions to output a fourth selection signal,
wherein the control unit, upon receiving the fourth selection signal from the distance sensing unit, transmits a fourth control signal corresponding to the fourth selection signal to the control target device to control the control target device such that a second object being output on a screen of the control target device is enlarged, reduced or moved in front, rear, left and right directions.

11. A method of control using a remote controller having a dual touch pad including a first touch pad and a second touch pad adjacent to the first touch pad, the method comprising:
sensing whether the dual touch pad is positioned in a longitudinal direction or in a traverse direction, by the remote controller; and
if the dual touch pad is positioned in a traverse direction, controlling a control target device to output a text entry box on a screen of the control target device, by the remote controller.

12. The method of claim 11, further comprising: after the outputting of the text entry box, controlling the control target device to reduce a size of the text entry box and to display a virtual key pad at a lower side of the text entry box when a key pad call bar provided at a lower side of a screen of the text entry box is dragged up through the dual touch pad, by the remote controller.

13. The method of claim 12, further comprising: after the outputting of the virtual key pad, prior to a contact of an object with respect to the first touch pad and the second touch pad, controlling the control target device to display a position of a finger on the virtual key pad, by the remote controller;
when the object makes contact with at least one of the first touch pad and the second touch pad, controlling the control target device to display the position of the finger on a key of the virtual key pad corresponding to a position at which the object makes the contact, and controlling the control target device to pre-select the key, by the remote controller; and
when the object making contact with one of the first touch pad and the second touch pad applies a pressure, controlling the control target device to display a symbol corresponding to the pre-selected key on the text entry box, by the remote controller.

14. A method of control using a remote controller having a dual touch pad including a first touch pad and a second touch pad adjacent to the first touch pad in which four direction keys are displayed on one of the first touch pad and the second touch pad, the method comprising:
when one of the four direction keys is pressed, sensing a pressure of the direction key being pressed, by the remote controller; and
transmitting movement speed of a cursor selecting one of the plurality of items displayed on a screen of a control target device according to the pressing pressure to the control target device to control the control target device to move the cursor along the plurality of items at the movement speed, by the remote controller.

15. The method of claim 14, wherein in the controlling of the control target device, the remote controller controls the control target device to display the movement speed of the cursor on the screen of the control target device according to the pressing pressure.
